(19) United States
(12) Patent Application Publication
(10) Pub. No.: US 2014/0288869 A1
(43) Pub. Date: Sep. 25, 2014

(54) FLUID DISPENSER CALIBRATION METHOD

(71) Applicant: CARRIER CORPORATION, Farmington, CT (US)

(72) Inventor: Joseph J. Scordato, Beloit, WI (US)

(73) Assignee: Carrier Corporation, Farmington, CT (US)

(21) Appl. No.: 14/356,305

(22) PCT Filed: Nov. 5, 2012
(86) PCT No.: PCT/US12/63507

§ 371 Date: May 5, 2014

Related U.S. Application Data
(60) Provisional application No. 61/557,102, filed on Nov. 8, 2011.

(51) Int. Cl. G01F 25/00

(52) U.S. Cl. CPC G01F 25/00
USPC 702/100

(57) ABSTRACT

A method of calibrating a dispenser includes dispensing a dose of product from a dispenser reset to an uncorrected state and measuring a single dose of product from a draw representative of an average dose (typically dispensed when the product tank is at mid-fill level). Pre-determined equations relating a calibration offset, a timing constant, desired portion sizes, and a degradation factor to the average expected dispense throughout a tank of product and the expected variation in these doses are employed to derive the degradation factor characteristic of the specific dispenser, calculate calibration and timing factors, and adjust the equipment dispense control function accordingly.

### BACKGROUND OF THE INVENTION

The subject matter disclosed herein relates to fluid dispensers. More specifically, the subject matter disclosed herein relates calibration of flow from fluid dispensers.

Dispensers, such as those dispensing liquids such as dairy products or the like or alternatively dry flows such as powders, are configured to deliver measured amounts, or doses, of the desired product when the dispensing process is initiated. The dispensing may be by for example, volume or weight, and may be initiated by, for example, pressing of a button or other activator. The activator actuates a dispensing mechanism for a set duration of time, over which it is expected that the desired amount is dispensed. Over the life of the dispenser, however, components of the dispenser degrade, resulting in inaccurate dispensing of product during the set time duration. Depending on the type of degradation, the amount actually dispensed may be greater or lower than is desired.

This problem is typically addressed by periodically calibrating the dispenser, effectively adjusting the set duration of time that the dispenser is activated, thereby correcting the dispensing error due to degradation. An operator is required to input a value into the dispenser to adjust an offset to attempt to bring the dispensed amount back to the desired amount. Unfortunately, this method of adjustment is unable to compensate for errors compounded over successive doses, usually requiring multiple iterations of trial and error. Another method employed requires the operator to input actual portion measurements from two portions dispensed widely spaced apart in sequence, i.e. not dispensed successively. This method defines a slope of the compounded error for readjustment of the dispenser. Unfortunately, acquiring these two widely-spaced portion measurements can be burdensome to the operator and often cannot effectively correct portion inaccuracies due to interaction between the “slope” and the “offset” values.

### BRIEF DESCRIPTION OF THE INVENTION

A method of calibrating a dispenser includes resetting the equipment and measuring a dose of product dispensed when the product level is mid-way in the product storage container. The measurement is entered into a dispenser control system and used in experimentally derived algorithms to calculate the characteristic friction factor due to equipment degradation. This value, in turn, is automatically used in experimentally derived algorithms to determine a timing offset and a timing constant to produce minimal variation in dosing without requiring manual iterations of further dispensing and measurement

Another method of calibrating a product dispenser includes dispensing a single dose of product from the dispenser and measuring the single dose of product. Both a revised timing constant and a revised dispensing time offset are determined from the measurement of the single dose of product, and the revised timing constant and the revised dispensing time offset are input into the dispenser.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an embodiment of a dispenser; and

FIG. 2 is a schematic representation of a method of calibrating a dispenser.

The detailed description explains embodiments of the invention, together with advantages and features, by way of example with reference to the drawings.

### DETAILED DESCRIPTION OF THE INVENTION

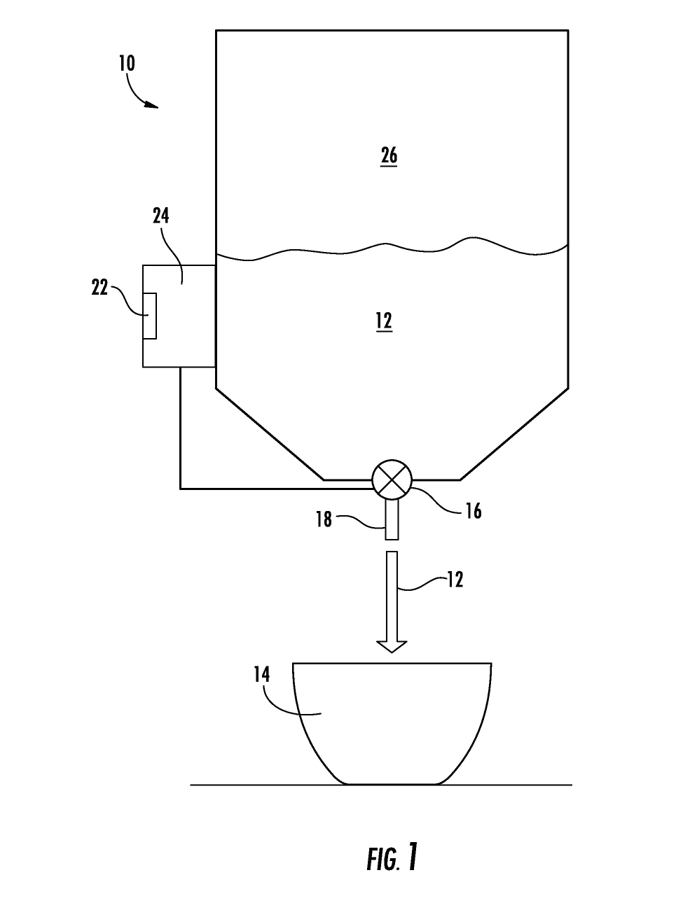

Shown in FIG. 1 is an embodiment of a dispenser 10. The dispenser 10 is configured to output a desired amount, or dose, of a product 12 into a receptacle, for example, a cup 14. The product 12 may be a liquid, such as a dairy product or the like, or a dry material such as a powder. The dispenser 10 may be configured to output the product from a tank 26 by opening an output valve 16 which allows the product 12 to flow, via gravity, through the output valve 16 and out of an outlet 18, then into the receptacle 14. In some embodiments, the output valve 16 is opened by pressing a button 22, or activating a switch (not shown), which is operably connected to the output valve 16 via a dispenser control system 24. This activation causes the output valve 16 to be opened for a specified duration of time, during which the product 12 is dispensed. Once the specified duration of time is reached, the output valve 16 is then closed, causing the dispensing of product 12 to cease until the output valve 16 is opened again. When the dispenser 10 is correctly calibrated, opening the output valve 16 for this specified duration of time will result in a correct dose of product 12 to be dispensed.

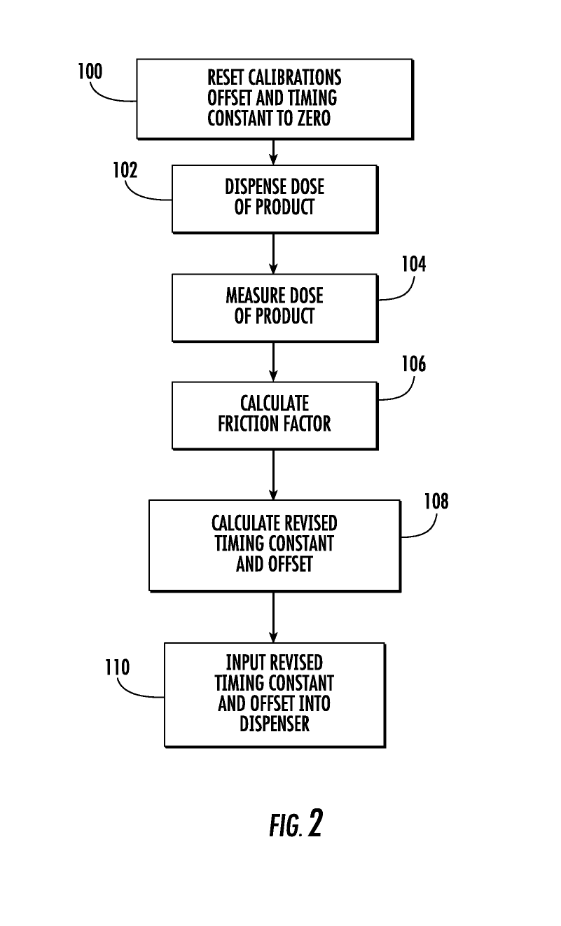

FIG. 2 illustrates a calibration method 20 for the dispenser 10. The calibration method utilizes two experimentally pre-determined mathematical relationships, typically in the form of regression equations, one regression equation for mean and one for a standard deviation. In software, such as that residing in the dispenser control system 24, these equations may be utilized via interpolation of data tables or other non-linear convergence methods. In these regression equations, the average amount dispensed is expressed relative to a nominal portion size (the correct dose), duration of time, a timing constant or change in timing per nominal dispense (which is used to vary a slope of the calibration curve), a friction factor that is a measure of wear or deterioration in the dispenser 10, and an offset (or calibration constant utilized to uniformly shift the calibration curve) to the duration of time (programmed into the dispenser control system). Example regression equations are shown below.

αₜₐₙₖ=B₁Cal+B₂τ+B₃P+B₄F+B₅(Cal)(τT)+B₆(Cal)(P)+. . . (1)

s_{tank=C}₁Cal+C₂τ+C₃P+C₄F+C₅(Cal)(τ)+C₆(Cal)(P)+. . . (2)

Where αₜₐₙₖ and sₜₐₙₖ are the mean and standard deviation, respectively, of the portion size, Cal is the calibration constant, τ is the timing constant, F is the friction factor, P is the nominal portion size, and B and C are machine dependent constants.

To calibrate the dispenser 10, referring to block 100, the calibration offset and the timing constant are automatically set to zero in the control algorithm of the dispenser control system 24 to clear any previous calibration corrections. In block 102, the output valve 16 is opened and a dose of product 12 is dispensed (typically when a tank 26 fill level of the dispenser 10 is at the mid-way level). Referring to block 104, the dose of product 12 is measured, typically by weighing or measuring volume, and used with a desired weight or volume of the product 12 to calculate the friction factor. The measurement is input into the dispenser control system 24, where, in block 106, the friction factor is calculated by setting αₜₐₙₖ equal to the measurement and solving the equation for F as shown in equation 3.

measurement=B₁(0)+B₂(0)+B₃P+B₄F+B₅(0)(0)+B₆(0)(P)+. . . or F=(measurement−B₃P)/B₄ (3)

With the average portion size and friction factor now known, dispenser control system 24 sets the “mean” equation equal to the nominal portion size whereas the “standard deviation” equation is set equal to zero to minimize expected portion variation. Referring to block 108, these two equations are solved for the two remaining variables, the timing constant and offset. In block 110, the new timing constant and offset are then automatically input into the dispenser control system 24 to finish calibration of the dispenser 10. In some embodiments, a second dose of product 12 may be dispensed to verify the calibration.

The method described herein is advantageous as it is necessary only to dispense a single dose of product 12 to perform the calibration. The method utilizes the single dose as an approximation of the average dose and assumes that the degradation captured by the friction factor is the sole cause of error in the amount of product dispensed. The method uses this single dose to calculate both a timing constant and offset, which previously required the dispensing of at least two doses spaced widely apart in sequence.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of calibrating a dispenser comprising:
dispensing a dose of product from a dispenser;
measuring the dose of product;
inputting the measurement into a dispenser control system;
comparing the measurement to a desired measurement to calculate a degradation factor via the dispenser control system;
determining a revised timing constant and a revised offset based on the measurement of the dose of product and the degradation factor; and
inputting the revised timing constant and revised offset into the dispenser control system.

2. The method of claim 1, wherein measuring the dose of product comprises one of weighing or measuring the volume of the dose of product.

3. The method of claim 1, further comprising determining the timing constant via two or more experimentally derived relationships.

4. The method of claim 1, wherein the measurement of the dose of product is equated with an average measurement.

5. The method of claim 1, wherein dispensing the dose of product from the dispenser comprises opening an output valve of the dispenser for a selected dispensing time.

6. The method of claim 1, wherein the dose of product is dispensed via gravity.

7. The method of claim 1, wherein the product is a liquid.

8. A method of calibrating a product dispenser comprising:
dispensing a single dose of product from the dispenser;
measuring the single dose of product;
determining both a revised timing constant and a revised dispensing time offset based on the measurement of the single dose of product; and
inputting the revised dispensing time and the revised dispensing time offset into the dispenser.

9. The method of claim 8, wherein measuring the dose of product comprises one of weighing or measuring a volume of the dose of product.

10. The method of claim 8, further comprising determining the revised timing constant and revised dispensing time offset via two or more experimentally derived relationships.

11. The method of claim 8, wherein the measurement of the dose of product is equated with an average measurement.

12. The method of claim 8, wherein dispensing the dose of product from the dispenser comprises opening an output valve of the dispenser for a selected dispensing time.

13. The method of claim 8, wherein the dose of product is dispensed via gravity.
